(19) United States
(12) Patent Application Publication
(10) Pub. No.: US 2016/0350622 A1
(43) Pub. Date: Dec. 1, 2016

(54) AUGMENTED REALITY AND OBJECT RECOGNITION DEVICE

(71) Applicant: OPTiM Corporation, Saga (JP)

(72) Inventor: Shunji SUGAYA, Tokyo (JP)

(21) Appl. No.: 14/982,206

(22) Filed: Dec. 29, 2015

(30) Foreign Application Priority Data
May 26, 2015 (JP) 2015-106554

(51) Int. Cl. G06K 9/78; G06T 19/00; H04N 5/225

(52) U.S. Cl. CPC G06K 9/78; H04N 5/2254; G06T 19/006

(57) ABSTRACT

The present invention is to provide an augmented reality and object recognition device appropriately recognizing an object of an image that has been taken, for augmented reality. The augmented reality and object recognition device 100 includes a camera unit 120 that includes a plurality of camera lenses 121 each with a different focal length and an imaging unit 122 taking a plurality of images of an object at the focal length of each of the plurality of camera lenses. The augmented reality and object recognition device 100 improving the recognition rate of an object can be provided by including the object recognition module 121 performing a recognition process to recognize the object from the plurality of images that have been taken by the imaging unit 122.

### CROSS REFERENCE TO RELATED APPLICATIONS

This application claims priority to Japanese Patent Application No. 2015-106554 filed on May 26, 2015, the entire contents of which are incorporated by reference herein.

### TECHNICAL FIELD

The present invention relates to an augmented reality and object recognition device taking an image of an object and recognizing the object from the image for augmented reality.

### BACKGROUND ART

In recent years, augmented reality (AR) has commonly been used as a technology to augment a real environment perceived by a person with a computer. There are various means to augment reality with a computer, such as seeing, hearing, and touching. For example, services to explain a place and an object with characters and voices have been implemented.

AR may or may not use a marker (index). Generally, marker AR, which uses a marker, recognizes a real environment based on feature points of a marker such as corners of a quadrangle. On the other hand, markerless AR, which does not use a maker, requires to have a process to calculate the coordinates of each feature point based on corner points and local feature amounts in an entire screen. Therefore, it is important for markerless AR to appropriately recognize an object from an image that has been taken.

To implement markerless AR, a device and a method for augmented reality, which do not need a marker (index) in a real environment, has been disclosed (Patent Document 1).

### CITATION LIST

### Patent Literature

Patent Document 1: JP 2013-528870 T

### SUMMARY OF INVENTION

In markerless AR, the key point is to appropriately recognize a general object not specialized in AR from an image of the object that has been taken, in particular. For the key point, the image of an object in a real environment, which has been taken, is important. When the image of an object is out of focus due to defocusing, blurring, etc. or does not have the whole object itself because a camera is too close to the object, markerless AR does not perform well. Therefore, the accuracy of a camera and the skill of a photographer are important.

However, only in the method of Patent Document 1, it must be said that markerless AR cannot perform when an appropriate image is not obtained due to the inaccuracy of a camera and the poor skill of a photographer. However, now that portable terminals have widely been used regardless of age or gender, the functions of a device should be improved to increase the recognition rate of an object for augmented reality regardless of terminal users' camera techniques.

An objective of the present invention is to an augmented reality and object recognition device including a plurality of camera lenses each with a different focal length to take a plurality of images each with a different focal length so that the recognition rate of the object is improved.

### SUMMARY OF INVENTION

The first aspect of the present invention provides an augmented reality and object recognition device including:

a lens unit that includes a plurality of camera lenses each with a different focal length;

an imaging unit that takes a plurality of images of an object at the focal length of each of the plurality of camera lenses; and

an object recognition unit that performs a recognition process to recognize the object for augmented reality from the plurality of images.

According to the first aspect of the present invention, an augmented reality and object recognition device includes:

a lens unit that includes a plurality of camera lenses each with a different focal length;

an imaging unit that takes a plurality of images of an object at the focal length of each of the plurality of camera lenses; and

an object recognition unit that performs a recognition process to recognize the object for augmented reality from the plurality of images.

The second aspect of the present invention provides the augmented reality and object recognition device according to the first aspect of the present invention, in which the plurality of camera lenses each with a different focal length are arranged in a column and a row and faced in the direction toward an object to be imaged.

According to the second aspect of the present invention, in the augmented reality and object recognition device according to the first aspect of the present invention, the plurality of camera lenses each with a different focal length are arranged in a column and a row and faced in the direction toward an object to be imaged.

The third aspect of the present invention provides the augmented reality and object recognition device according to the first aspect of the present invention, in which the plurality of camera lenses each with a different focal length are uniformly arranged on the surface of a sphere.

According to the third aspect of the present invention, in the augmented reality and object recognition device according to the first aspect of the present invention, the plurality of camera lenses each with a different focal length are uniformly arranged on the surface of a sphere.

The present invention can provide an augmented reality and object recognition device including: a lens unit that includes a plurality of camera lenses each with a different focal length; an imaging unit that takes a plurality of images of an object at the focal length of each of the plurality of camera lenses; and an object recognition unit that performs a recognition process to recognize the object for augmented reality from the plurality of images, so as to improve the recognition rate of an object.

### BRIEF DESCRIPTION OF DRAWINGS

FIG. 1 is a diagram showing the outline of an augmented reality and object recognition device according to a preferable embodiment of the present invention.

FIG. 2 is a function block diagram of the augmented reality and object recognition device 100 of the present invention to show the relationship among the functions of the device.

FIG. 3 is a flow chart of the object recognition process performed by the augmented reality and object recognition device 100 of the present invention.

FIG. 4 is a pattern diagram of one camera lens 121 and one imaging unit 122 that are included in the camera unit 120.

FIG. 5 is an example of the camera unit 120 of the present invention.

FIG. 6 is another example of the camera unit 120 of the present invention.

FIG. 7 is an example of the camera unit 120 of the present invention which is arranged on the surface of a sphere.

FIG. 8 is a function block diagram of the augmented reality and object recognition device 1000 and the server 2000 when the object recognition process of the present invention is performed by the server 2000 to show the relationship among the respective functions of the device and the server.

FIG. 9 is a flow chart of the process performed by the augmented reality and object recognition device 1000 when the object recognition process of the present invention is performed by the server 2000.

FIG. 10 is a flow chart of the process performed by the server 2000 when the object recognition process of the present invention is performed by the server 2000.

FIG. 11 is a flow chart of the process performed by the augmented reality and object recognition device 1000 when the object recognition process and the AR image processing process of the present invention are performed by the server 2000.

FIG. 12 is a flow chart of the process performed by the server 2000 when the object recognition process and the AR image processing process of the present invention are performed by the server 2000.

### DESCRIPTION OF EMBODIMENTS

Embodiments of the present invention will be described with reference to the attached drawings. However, this is illustrative only, and the technological scope of the present invention is not limited thereto.

The augmented reality and object recognition device 100 includes a camera unit 120 that includes a plurality of camera lenses 121 each with a different focal length and an imaging unit 122 taking a plurality of images at the focal length of each of the plurality of camera lenses. The augmented reality and object recognition device 100 performs a recognition process to recognize the object for augmented reality from the images obtained by the imaging unit 122 by using an object recognition module 111.

### Augmented Reality and Object Recognition Device 100

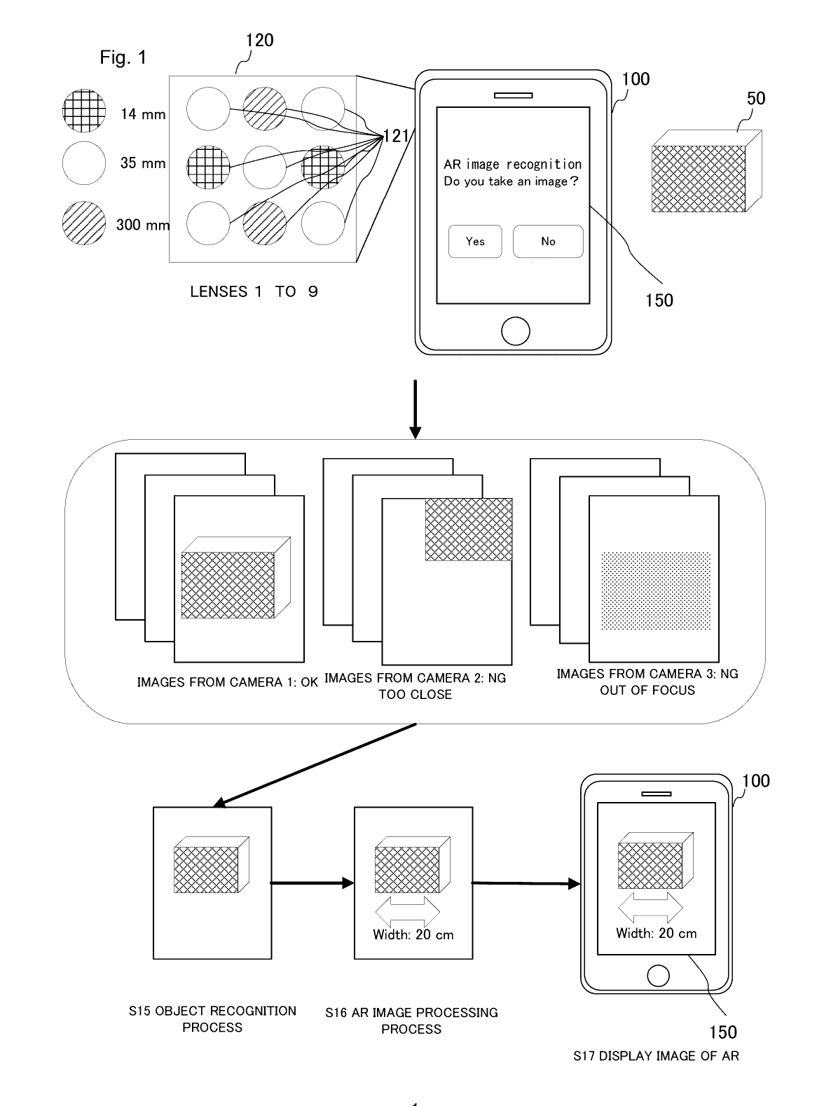

FIG. 1 is a diagram showing the outline of an augmented reality and object recognition device 100 according to a preferable embodiment of the present invention. The augmented reality and object recognition device 100 is explained in reference to FIG. 1.

The augmented reality and object recognition device 100 includes a control unit 110, a camera unit 120, a memory unit 130, and an input-output unit 150. The camera unit 120 is provided with a lens unit 121 that includes a plurality of camera lenses and an imaging unit 122 taking a plurality of images at the focal length of each of the plurality of camera lenses.

The augmented reality and object recognition device 100 may be a smart phone, a tablet PC, a digital camera, a wearable device, a security camera, or a general information appliance such as a PC provided with a camera function. The smart phone shown as the augmented reality and object recognition device 100 in attached drawings is just one example.

First, a user instructs the control unit 110 to take an image by using the input-output unit 150 of the augmented reality and object recognition device 100 to perform the AR function on an object 50 (step S11). At this time, in the augmented reality and object recognition device 100, the application program (hereinafter referred to as “app”) to perform the AR function shall be executed.

The input-output unit 150 shall have a display function to display a message to the user to determine whether or not to take an image with the camera and a button function to receive a user's input determination as shown in FIG. 1 so as to perform the AR function. The button function may be displayed in the liquid crystal display to receive a user's input determination by the touch panel or may receive a user's input determination from the hardware button and the keyboard on the device. The control unit 110 receives the instruction from the input-output unit 150 and instructs the camera unit 120 to take an image (step S12).

When receiving this instruction, the camera unit 120 takes a plurality of images of the object 50 at the focal length of each of the plurality of camera lenses by using the lens unit 121 that includes a plurality of camera lenses each with a different focal length and the imaging unit 122 (step S13).

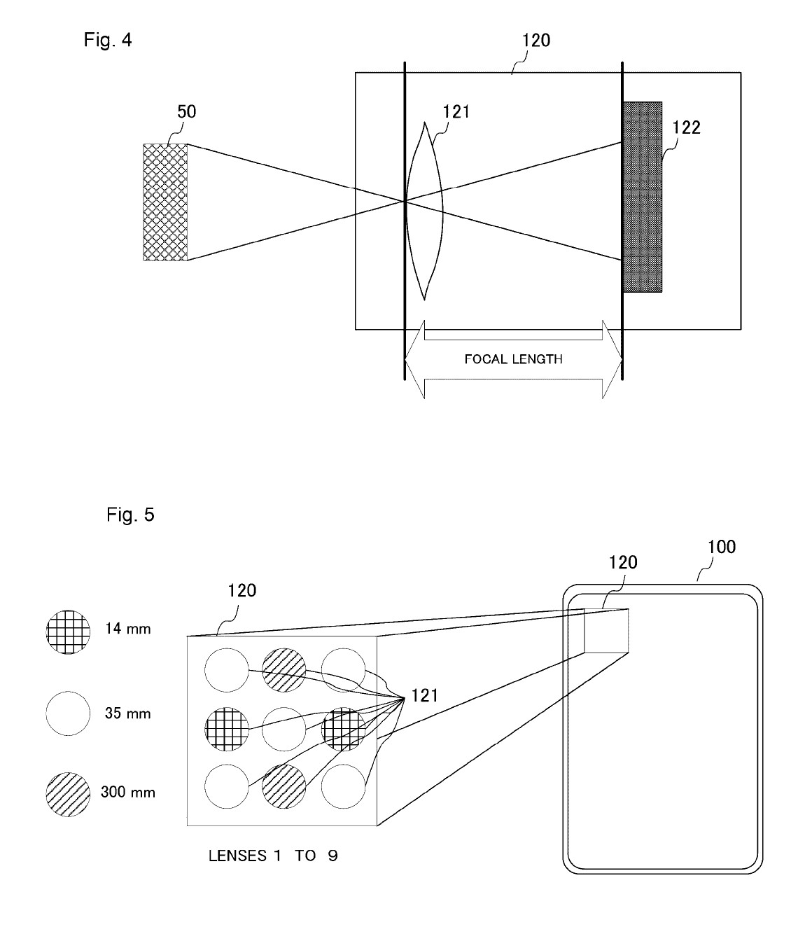

The camera unit 120 projects the object 50 to be imaged on the imaging unit 122 through the lens unit 121 as shown in FIG. 4. The imaging unit 122 is provided with an image sensor such as CCD. The imaging unit 122 shall be disposed at an appropriate distance from the lens unit 121 because the focal length between the lens unit 121 and the imaging unit 122 differs according to the camera lens.

FIGS. 1 and 5 show an example in which the camera unit 120 is provided with nine lenses each with a 35 mm equivalent focal length of 14 mm, 35 mm, or 300 mm which are arranged in 3 columns and 3 rows. However, the arrangement of a plurality of camera lenses and the selection method of focal lengths are not limited to these and can be changed according to the size of an object to be imaged, the distance between the object and the camera, or the desired imaging range. In this example, the focal lengths are different. However, the settings other than the focal lengths, such as the apertures, the exposure times, and the ISO sensitivities can also be different.

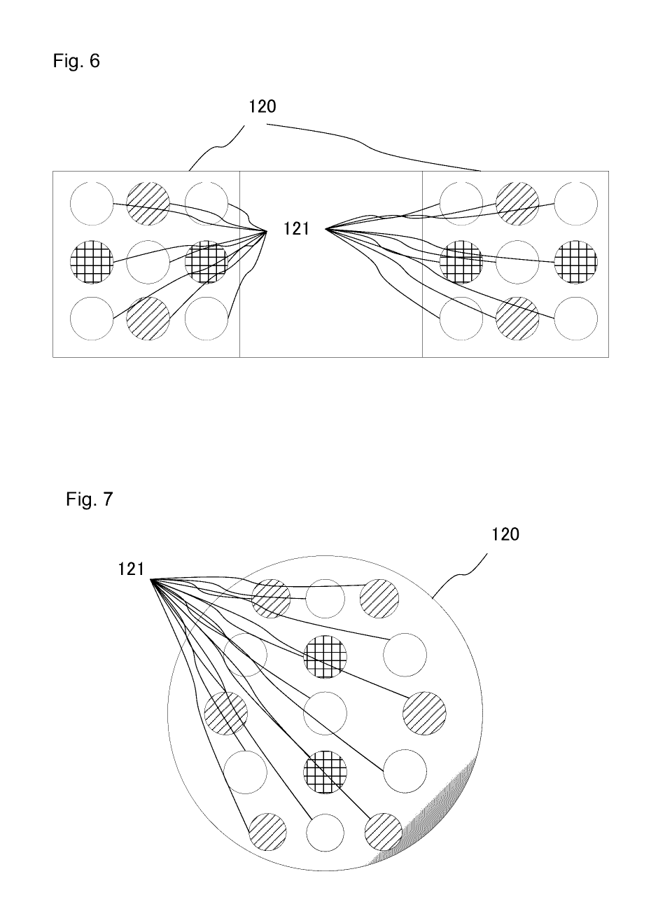

For example, as shown in FIG. 6, the camera unit can be separated in two parts, and the two parts are horizontally arranged, so as to obtain wider-ranging images.

Moreover, as shown in FIG. 7, camera lenses can be uniformly arranged on the surface of a sphere, for example, to form a mirror ball, so as to obtain 360-degree images.

Then, the memory unit 130 stores the plurality of images that have been taken in the step S13 (step S14). The memory unit 130 may have a database necessary for the object recognition process (step S15) to be described later and a database necessary for the AR image processing process (step S16) to be described later.

The control unit 110 performs the object recognition process by using the plurality of images stored in the memory unit 130 (step S15). The process herein removes NG images such as images in which the object is off from the imaging range and images from which a corner point and a local feature amount cannot be detected because the object 50 is out of focus or too small. Then, this process recognizes the object by using OK images that are left. Any algorithms can be used in the recognition process herein. In this example, the plurality of still images are obtained, but the algorithm for extracting a plurality of images from a moving image to recognize the object may be applied.

When provided with a database necessary for the object recognition process (step S15) in the memory unit 130, the control unit 110 sequentially accesses the memory unit 130 to acquire data as appropriate during the object recognition process. The memory unit 130 may store the data after the object recognition process for next processing.

After performing the object recognition process, the control unit 110 performs the AR image processing process (step S16). This process shall be performed in accordance with the function of an app to perform the AR function. For example, this process generates that the object 50 has a width of 20 cm as shown in FIG. 1.

When provided with a database necessary for the AR image processing process (step S16), the control unit 110 sequentially accesses the memory unit 130 to acquire data as appropriate during the AR image processing process. The memory unit 130 may store the data after the AR image processing process.

Finally, the generated image of AR is displayed in the input-output unit 150, and then a series of processing steps are ended (step S17). The image of AR can be displayed in various ways. For example, the image of AR may displayed in the liquid crystal display of a smart phone, a tablet PC, a digital camera, and a wearable device, the display of PC or may be projected on the external screen with a projector.

### Functions

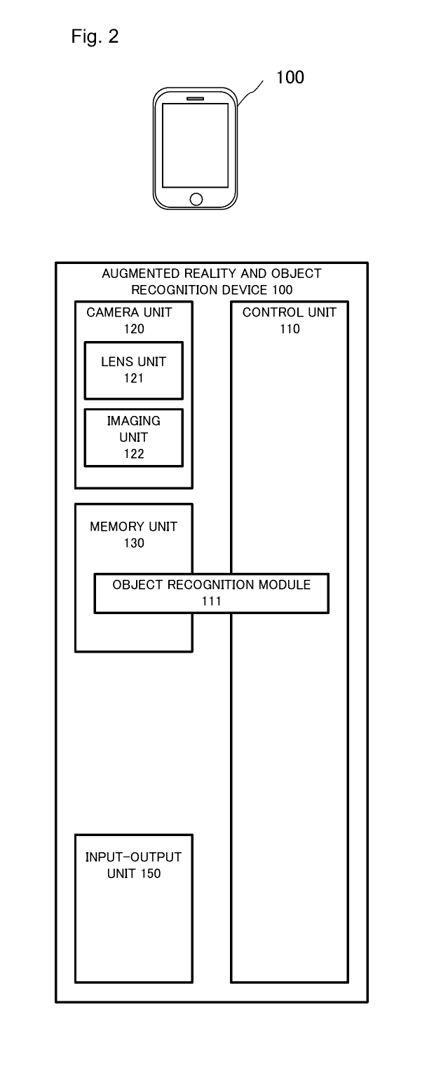

FIG. 2 is a function block diagram of the augmented reality and object recognition device 100 to show the relationship among the functions of the device.

In the augmented reality and object recognition device 100, the control unit 110 includes CPU (Central Processing Unit), RAM (Random Access Memory), and ROM (Read Only Memory).

In the augmented reality and object recognition device 100, the control unit 110 reads a predetermined program to run an object recognition module 111 in cooperation with the memory unit 130.

The augmented reality and object recognition device 100 includes a camera unit 120 that includes a plurality of camera lenses each with a different focal length as the lens unit 121 and an imaging unit 122 provided with an image sensor such as CCD to take a plurality of images at the focal length of each of the plurality of camera lenses.

The input-output unit 150 may include a liquid crystal display to achieve a touch panel function, a hardware button and a keyboard on the device, and a microphone to perform voice recognition as the input unit. The input-output unit 150 may take various forms such as a liquid crystal display, a PC display, and a projector projecting images on an external screen as the output unit. The features of the present invention are not limited in particular by an input-output method.

### Object Recognition Process

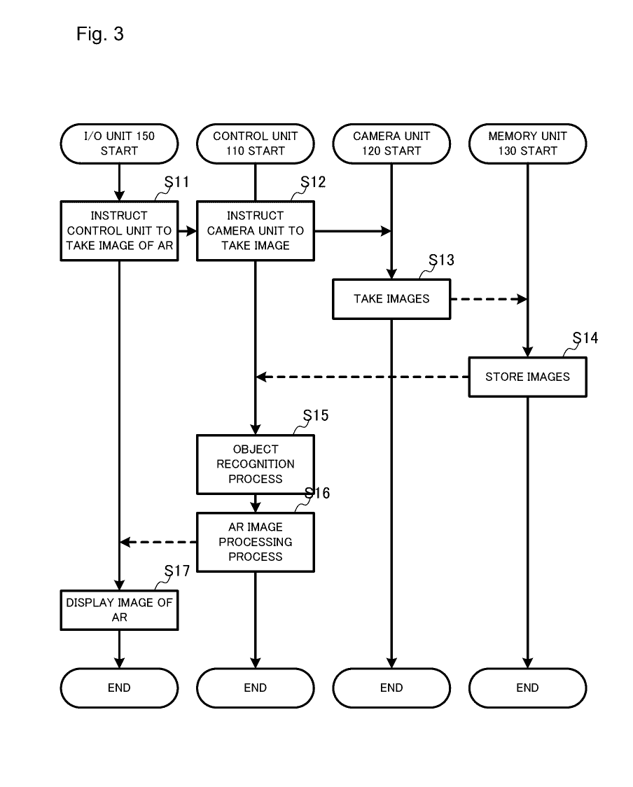

FIG. 3 is a flow chart of the object recognition process performed by the augmented reality and object recognition device 100. The process performed by the units and the modules of the above-mentioned device is explained together with this process.

First, the input-output unit 150 of the augmented reality and object recognition device 100 receives an input for instruction to take an image for AR and transmits this instruction to the control unit 110 (step S11).

The control unit 110 receives this instruction and instructs the camera unit 120 to take an image (step S12).

The camera unit 120 takes a plurality of images by using a lens unit that includes a plurality of camera lenses 121 each with a different focal length and an imaging unit 122 taking a plurality of images at the focal length of each of the plurality of camera lenses (step S13).

The plurality of images that have been taken by the camera unit 120 are stored in the memory unit 130 (step S14) and then subjected to the object recognition process by the control unit 110 (step S15).

The object recognition process removes NG images from the plurality of images to use OK images. The NG images are images from which a corner point and a local feature amount cannot be detected because the images are out of focus or because the object is too small in the images. If provided with more than one camera each including camera lenses each with a different focal length to obtain wider-ranging images with more than one camera, the augmented reality and object recognition device 100 is promising for obtaining OK images.

If obtained in the object recognition process, more than one OK image can be used to more accurately recognize an object. Any algorithms can be used in the recognition process herein. The recognition process herein does not limit the present invention.

If the object recognition process is required to look up a database, the memory unit 130 may be provided with the database to allow the process to look up. The memory unit 130 may store the data after the object recognition process.

Then, the control unit 110 performs the AR image processing process on the image data obtained by the object recognition process (step S16).

Since there are various services to explain what a user is looking at by words and sound in AR, not only image processing for display but also data creation for voice output may be performed in this step. FIG. 1 shows an example in which image data to display that the object 50 has a width of 20 cm is generated and displayed. However, an appropriate process shall be performed in accordance with the functions of the augmented reality and object recognition device and the content of the app and the service to perform the AR function.

If the AR image processing process is required to look up a database, the memory unit 130 may be provided with the database to allow the process to look up. The memory unit 130 may store the data after the AR image processing process.

Finally, the input-output unit 150 displays the generated image of AR (step S17). The generated image of AR shall be displayed in accordance with the function of the output unit such as a display or an external screen as the display unit, herein. If there are voice output data, the input-output unit 150 may output this data at the same time.

Functions when Object Recognition Process is Performed by Server 2000

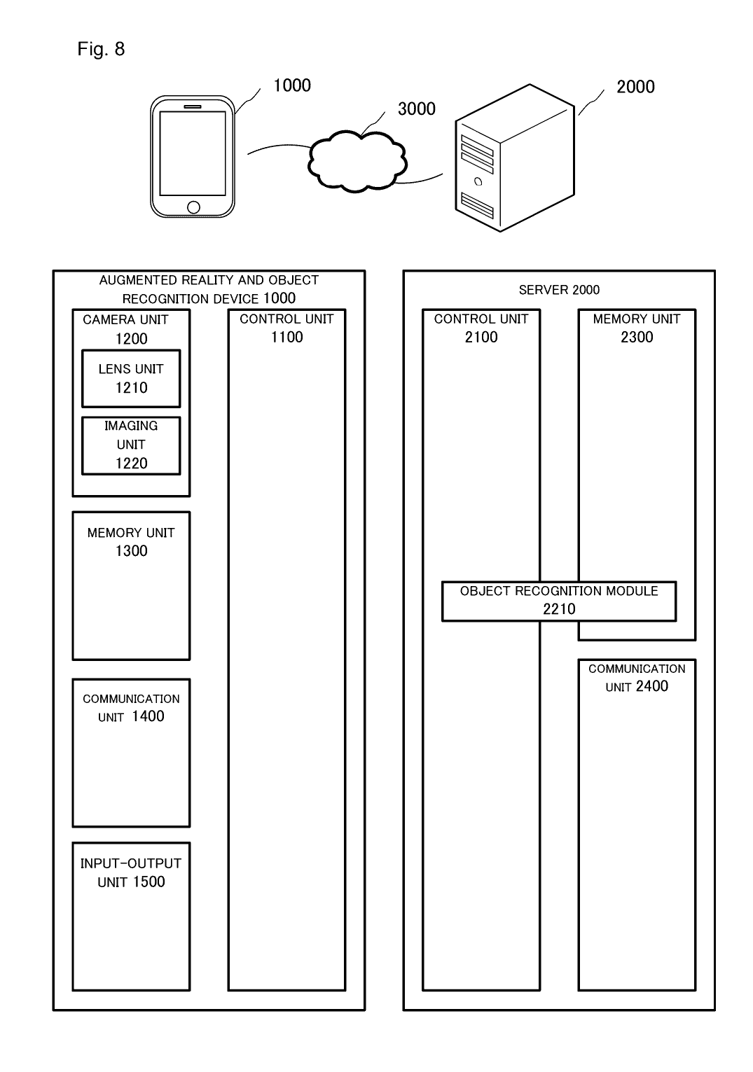

FIG. 8 is a function block diagram of the augmented reality and object recognition device 1000 and the server 2000 when the object recognition process of the present invention is performed by the server 2000 to show the relationship among the respective functions of the device and the server.

The augmented reality and object recognition device 1000 shall be connectively connected with the server 2000 through a public line network 3000 such as the Internet network.

The augmented reality and object recognition device 1000 may be a smart phone, a tablet PC, a digital camera, a wearable device, a security camera, or a general information appliance such as a PC that are provided with a communication function. The smart phone shown as augmented reality and object recognition device 1000 in attached drawings is just one example.

The server 2000 may be a general server provided with the object recognition function to be described later.

The augmented reality and object recognition device 1000 include a control unit 1100 provided with CPU, RAM, ROM, etc.

In the augmented reality and object recognition device 1000, the control unit 1100 transmits an instruction to the server 2000 to perform the object recognition process or both the object recognition process and the AR image processing process.

The augmented reality and object recognition device 1000 includes a camera unit 1200 that includes a plurality of camera lenses each with a different focal length as the lens unit 1210 and an imaging unit 1220 provided with an image sensor such as CCD to take a plurality of images of an object at the focal length of each of the plurality of camera lenses.

The augmented reality and object recognition device 1000 also includes a communication unit 1400 to transmit images that have been taken to the server 2000 and to receive an image obtained from the object recognition process or an image of AR from the server 2000.

The augmented reality and object recognition device 1000 includes an input-output unit 1500. The input-output unit 1500 may include a liquid crystal display to achieve a touch panel function, a hardware button and a keyboard on the device, and a microphone to perform voice recognition as the input unit. The input-output unit 1500 may take various forms such as a liquid crystal display, a PC display, and a projector projecting images on an external screen as the output unit. The features of the present invention are not limited in particular by an input-output method.

Processing when Object Recognition Process is Performed by Server 2000

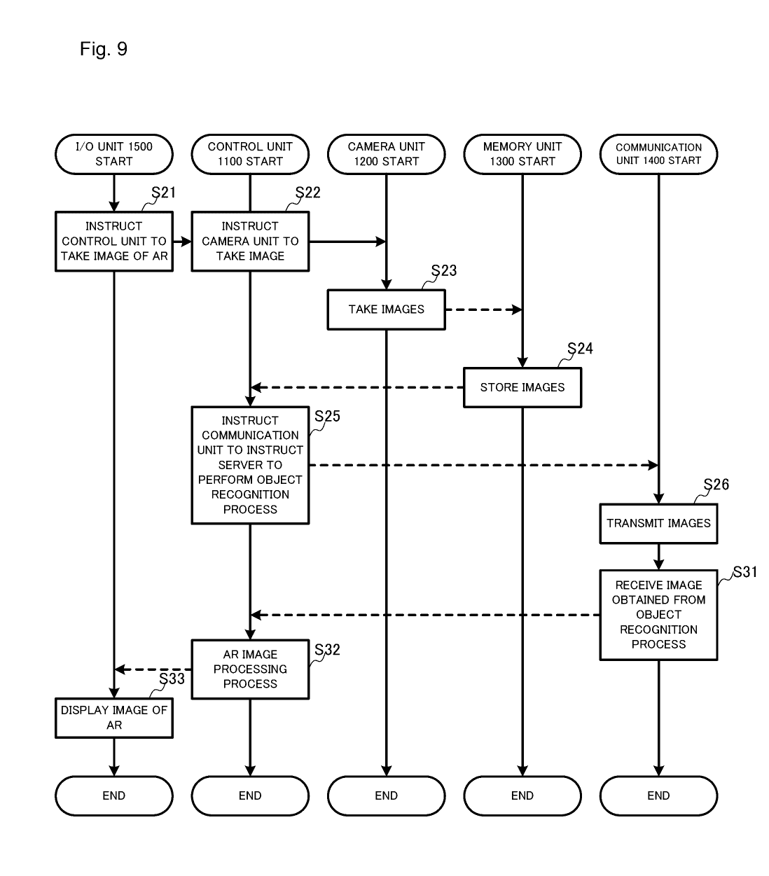

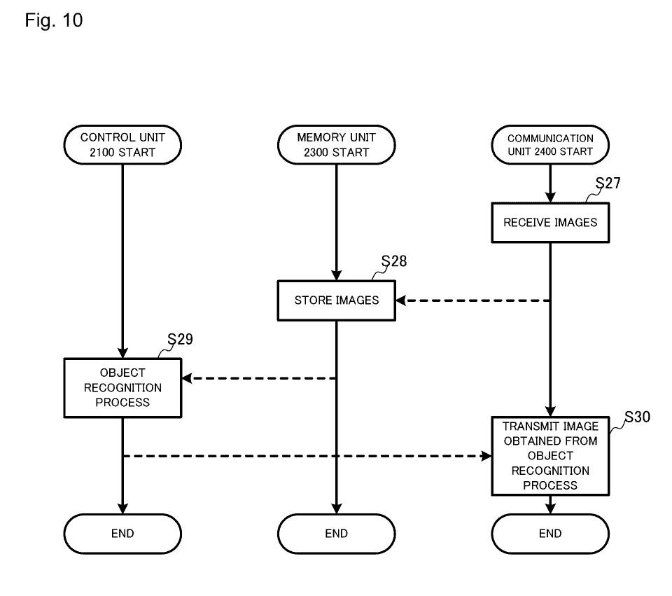

FIG. 9 is a flow chart of the process performed by the augmented reality and object recognition device 1000 when the object recognition process is performed by the server 2000. FIG. 10 is a flow chart of the process performed by the server 2000 when the object recognition process is performed by the server 2000. The process performed by the units and the modules of the above-mentioned device is explained together with this process.

As shown in FIG. 9, first, the input-output unit 1500 of the augmented reality and object recognition device 1000 receives an input for instruction to take an image for AR and transmits this instruction to the control unit 1100 (step S21).

The control unit 1100 receives this instruction and instructs the camera unit 1200 to take an image (step S22).

The camera unit 1200 takes a plurality of images by using a lens unit that includes a plurality of camera lenses 1210 each with a different focal length and an imaging unit 1220 taking a plurality of images of an object at the focal length of each of the plurality of camera lenses (step S23).

The plurality of images that have been taken by the camera unit 1200 are stored in the memory unit 1300 (step S24). Then, the control unit 1100 instructs the communication unit 1400 to transmit an instruction to the server to perform the object recognition process (step S25).

The communication unit 1400 receives the instruction from the control unit 1100 and transmits an instruction to the server 2000 together with images that have been taken to perform the object recognition process through a public telecommunication network 3000 (step S26).

Then, the server 2000 performs the process shown in FIG. 10.

The communication unit 2400 of the server 2000 receives the images that have been taken from the augmented reality and object recognition device 1000 together with an instruction to perform the object recognition process (step S27).

Then, the memory unit 2300 stores the plurality of received images (step S28). Subsequently, the object recognition module 2210 executed by the control unit 2100 performs the object recognition process (step S29).

The object recognition process removes NG images from the plurality of images to use OK images. The NG images are images from which a corner point and a local feature amount cannot be detected because the images are out of focus or because the object is too small in the images. If provided with more than one camera each including camera lenses each with a different focal length to obtain wider-ranging images with more than one camera, the augmented reality and object recognition device 1000 is promising for obtaining OK images.

If obtained in the object recognition process, more than one OK image can be used to more accurately recognize an object. Any algorithms can be used in the recognition process herein. The recognition process herein does not limit the present invention.

If the object recognition process is required to look up a database, the memory unit 2300 of the server 2000 may be provided with the database to allow the process to look up. The memory unit 2300 may store the data after the object recognition process.

Then, the communication unit 2400 transmits an image obtained from the object recognition process to the augmented reality and object recognition device 1000 (step S30).

Subsequently, the augmented reality and object recognition device 1000 performs the step S31 shown in FIG. 9.

The communication unit 1400 receives the image obtained from the object recognition process from the server 2000 (step S31). The received image may be one image finally selected or may be more than one OK image in which the object could be recognized by the object recognition module.

The control unit 1100 performs the AR image processing process on the received image obtained from the object recognition process (step S32).

In this step, not only image processing for display but also data creation for voice output may be performed. Furthermore, an appropriate process shall be performed in accordance with the functions of the augmented reality and object recognition device and the content of the app and the service to perform the AR function.

If the AR image processing process is required to look up a database, the memory unit 1300 of the augmented reality and object recognition device 1000 may be provided with the database to allow the process to look up. The memory unit 1300 may store the data after the AR image processing process.

Finally, the input-output unit 1500 displays the generated image of AR (step S33). The generated image of AR shall be displayed in accordance with the function of the output unit such as a display or an external screen as the display unit, herein. If there are voice output data, the input-output unit 1500 may output this data at the same time.

Processing when Object Recognition Process and AR Image Processing Process are Executed by Server 2000

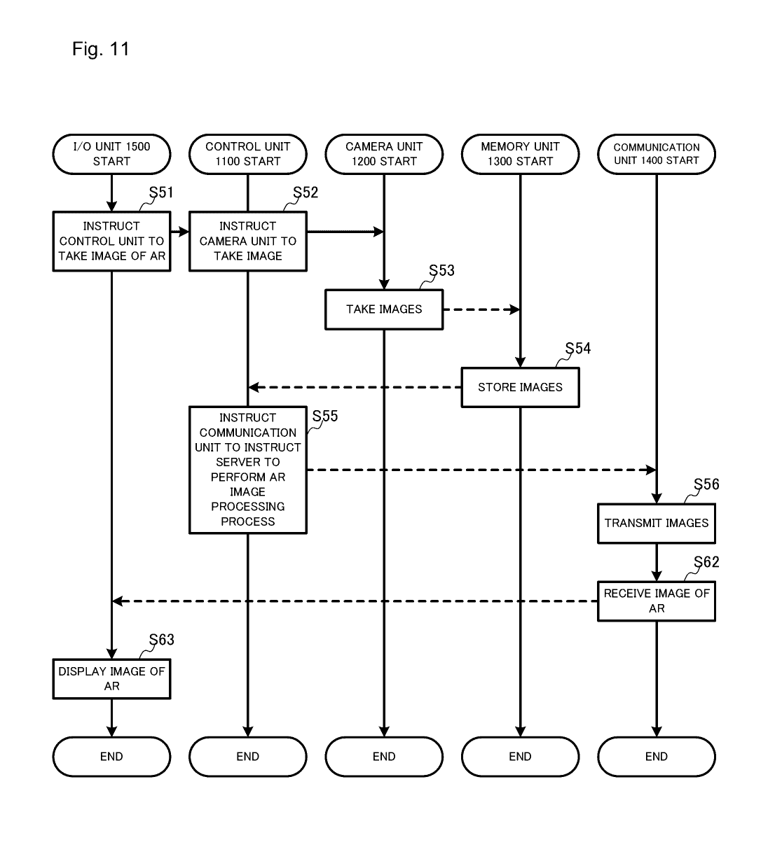

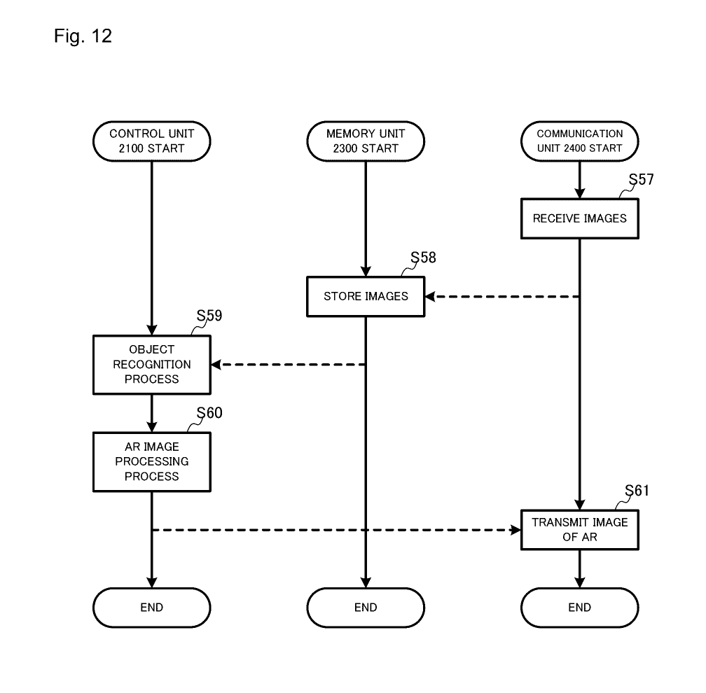

FIG. 11 is a flow chart of the process performed by the augmented reality and object recognition device 1000 when the object recognition process and the AR image processing process of the present invention are performed by the server 2000. FIG. 12 is a flow chart of the process performed by the server 2000 when the object recognition process and the AR image processing process of the present invention are performed by the server 2000. The process performed by the units and the modules of the above-mentioned device is explained together with this process.

As shown in FIG. 11, first, the input-output unit 1500 of the augmented reality and object recognition device 1000 receives an input for instruction to take an image for AR and transmits this instruction to the control unit 1100 (step S51).

The control unit 1100 receives this instruction and instructs the camera unit 1200 to take an image (step S52).

The camera unit 1200 takes a plurality of images by using a lens unit that includes a plurality of camera lenses 1210 each with a different focal length and an imaging unit 1220 taking a plurality of images of an object at the focal length of each of the plurality of camera lenses (step S53).

The plurality of images that have been taken by the camera unit 1200 are stored in the memory unit 1300 (step S54). Then, the control unit 1100 instructs the communication unit 1400 to transmit an instruction to the server to perform the AR image processing process (step S55).

The communication unit 1400 receives the instruction from the control unit 1100 and transmits an instruction to the server 2000 together with images that have been taken to perform the AR image processing process through a public telecommunication network 3000 (step S56).

Then, the server 2000 performs the process shown in FIG. 12.

The communication unit 2400 of the server 2000 receives the images that have been taken from the augmented reality and object recognition device 1000 together with an instruction to perform the AR image processing process (step S57).

Then, the memory unit 2300 stores the plurality of received images (step S58). Subsequently, the object recognition module 2210 executed by the control unit 2100 performs the object recognition process (step S59).

The object recognition process removes NG images from the plurality of images to use OK images. The NG images are images from which a corner point and a local feature amount cannot be detected because the images are out of focus or because the object is too small in the images. If provided with more than one camera each including camera lenses each with a different focal length to obtain wider-ranging images with more than one camera, the augmented reality and object recognition device 1000 is promising for obtaining OK images.

If obtained in the object recognition process, more than one OK image can be used to more accurately recognize an object. Any algorithms can be used in the recognition process herein. The recognition process herein does not limit the present invention.

If the object recognition process is required to look up a database, the memory unit 2300 of the server 2000 may be provided with the database to allow the process to look up. The memory unit 2300 may store the data after the object recognition process.

Then, the control unit 2100 performs the AR image processing process (step S60).

In this step, not only image processing for display but also data creation for voice output may be performed. Furthermore, an appropriate process shall be performed in accordance with the functions of the augmented reality and object recognition device and the content of the app and the service to perform the AR function.

If the AR image processing process is required to look up a database, the memory unit 2300 of the server 2000 may be provided with the database to allow the process to look up. The memory unit 2300 may store the data after the AR image processing process.

Then, the communication unit 2400 transmits an image of AR that has obtained from the AR image processing process and output data to the augmented reality and object recognition device 1000 (step S61).

Subsequently, the augmented reality and object recognition device 1000 performs the step S62 shown in FIG. 11.

The communication unit 1400 receives the image of AR and output data from the server 2000 (step S62).

Finally, the input-output unit 1500 displays the received image of AR and outputs the received output data as appropriate (step S63). Data shall be displayed and output in accordance with the function of the output unit, herein.

The embodiments of the present invention are described above. However, the present invention is not limited to the above-mentioned embodiments. The effects described in the embodiments of the present invention are only the most preferable effect produced from the present invention. The effects of the present invention are not limited to that described in the embodiments of the present invention.

### REFERENCE SIGNS LIST

50 Object
100 Augmented reality and object recognition device
1000 Augmented reality and object recognition device
2000 Server
3000 Public line network

What is claimed is:

1. An augmented reality and object recognition device comprising:
a lens unit that includes a plurality of camera lenses each with a different focal length;
an imaging unit that takes a plurality of images of an object at the focal length of each of the plurality of camera lenses; and
an object recognition unit that performs a recognition process to recognize the object for augmented reality from the plurality of images.

2. The augmented reality and object recognition device according to claim 1, wherein the plurality of camera lenses each with a different focal length are arranged in a column and a row and faced in the direction toward an object to be imaged.

3. The augmented reality and object recognition device according to claim 1, wherein the plurality of camera lenses each with a different focal length are uniformly arranged on the surface of a sphere.
